(19) United States
(12) Patent Application Publication
(10) Pub. No.: US 2007/0297560 A1
(43) Pub. Date: Dec. 27, 2007

(54) Method and system for electronic unpacking of baggage and cargo

(75) Inventors: Samuel Moon-Ho Song, Las Vegas, NV (US); Douglas Perry Boyd, Las Vegas, NV (US)

Correspondence Address: THE SMALL PATENT LAW GROUP LLP, 611 OLIVE STREET, SUITE1611, ST. LOUIS, MO, 63101, US

(73) Assignee: TELESECURITY SCIENCES, INC.

(21) Appl. No.: 11/702,794

(22) Filed: Feb. 5, 2007

Related U.S. Application Data
(60) Provisional application No. 60/779,133, filed on Mar. 3, 2006.

(51) Int. Cl. G01N 23/04

(52) U.S. Cl. 378/4; 378/57

(57) ABSTRACT

In accordance with certain embodiments a method and system to analyze the content of a packed bag utilizing a scanner is provided. The bag is scanned for a scannable characteristic to acquire scan data representative of a content of the piece of baggage. A volumetric data set is generated from the scan data, wherein the volumetric data set includes voxel values of the scannable characteristic throughout a volume of interest in the baggage. A rendered view is produced of the content of the piece of baggage based on the voxel values within a selected range from the volumetric data set. The method and system also provide identifying a threat by analyzing Hounsfield Units of the material of interest.

### CROSS-REFERENCE TO RELATED APPLICATIONS

This application claims priority to U.S. Provisional Patent Application No. 60/779,133, filed Mar. 3, 2006, the complete subject matter from all of which is expressly incorporated herein by reference in its entirety.

### BACKGROUND OF THE INVENTION

Certain embodiments generally relate to methods and systems for providing remote access to baggage scanned images and passenger security information.

In recent years there has been increasing interest in the use of imaging devices at airports to improve security. The President of the United States signed the Aviation and Transportation Security Act on Nov. 19, 2001, which, among other things, mandated that all checked luggage should be inspected by an explosives detection system (EDS). The Federal Aviation Administration (FAA), now the Transportation Safety Administration (TSA), a division of Homeland Security Administration (HAS), has set standards for qualifying explosives detection systems. To date all certified systems have represented computed tomography (CT) scanners and in one instance, a diffraction imaging (DI) scanners. Today thousands of CT scanners are installed at airports to scan checked baggage. The CT and DI scanners generate data sets that are used to form images representative of each scanned bag. The data sets are processes by an automated image recognition system, such as for certain patterns, characteristics and the like. When the image recognition system identifies a potential threat, the images are brought to the attention of an operator. The scanners are operated by TSA personnel who view cross sectional images of the baggage that is identified by the automated detection software to be a possible threat.

The scanners are capable of producing fully 3-dimensional (3-D) images. However, the software required to view such 3-D images is complex and generally requires sophisticated operators with expertise in 3-D rendering software tools. CT scanners are able to generate a 3-D voxel data set that represents the volume of the scanned bag. Conventionally, scanners provide 3-D images by stacking a series of closely spaced cross section images into a 3-D matrix. The 3-D image may then be viewed by an operator/screener. The operator usually steps through two-dimensional (2-D) slices (e.g., planes) of the 3-D matrix to detect and identify potential threats within the packed bag. Thus, the current procedure requires a highly trained operator with substantial expertise for the reliable detection of threats.

Currently, existing CT based explosive detection systems (EDS) are deployed at airports to detect various threats within packed bags. The suspicious bags are passed onto a human screener who examines individual CT slice images of the scanned bag. The CT slice images of alarmed bags are carefully examined by the human screener who then either accepts or redirects the bag for explosive trace detection (ETD) and/or manual unpacking for a visual inspection. This two step process allows approximately 250 bags per hour to be examined with a false-alarm rate of about 20-30%.

Unfortunately, the individual CT scanners will be operating on a stand-alone basis even though current and potentially future CT scanners may be on a network such as the Internet that allows access from the outside world. Without the appropriate tools, the screener, who sits next to one of the scanners, views the scanned CT images either to accept or reject the bag for further inspection. The overall false alarm rate will depend upon the ability and experience of the screener sitting next to the scanner, for a more experienced screener will have a lower false alarm rate than a less experienced screener. A screener operating in this stand-alone basis does not have the capability to receive advice or consult with a more experienced screener. Currently, one in five bags must be further inspected by carefully reviewing CT slice images.

Nondestructive testing techniques aim to detect certain features inside or outside of an object of interest to evaluate physical and mechanical characteristics of the object without harming the object. For instance, an ultrasonic pulse-echo technique is conventionally used to detect metal objects that are hidden inside of a package. However, the shape and position of potential explosive devices may vary and sometimes threat resolution may require a detailed knowledge of the chemical properties of the explosives and the physics of the packaging.

Further, the demands placed on scanner operators are further exaggerated by the time pressures of the application. The time pressures result from the need to examine baggage between the time that the baggage is checked and loaded on a flight. Often travelers check-in only shortly before their scheduled departure time, thereby permitting little time for the scanner operator to view the baggage.

After the baggage is check-in, the baggage is scanned by a CT scanner and axial slices or images are created of the baggage. The operator/screener views the axial slices or images by scrolling through each image slice one by one to determine if any potential threats are present in an image. Scrolling through over dozens of images (or even more for future generation scanners) for each bag is a laborious task, and the operator/screener must be alert to detect features of any potential threats within an image in order to flag the possible threats. Examination of each axial slice image gives rise to operator/screener fatigue that eventually will lead to sub-optimal performance by the operator causing him/her to miss some threats. For example, a bag that simulates a piece of luggage containing explosive stimulants (e.g., two bars of soap) that are hidden inside a radio underneath one the speakers is scanned. After a bag is checked, a CT 3-D data set of a packed bag is obtained and may, for example, include hundreds of axial slice images. Of these images only a few images may show the potential threat. If the operator misses anyone of these few images, the undetected threats could result in disaster.

There is a need for an improved baggage scanning system and method, to electronically unpack a scanned bag that provides views of inside of a packed bag such as without having to physically unpack the bag, or without having to harm the bag.

### BRIEF DESCRIPTION OF THE INVENTION

In accordance with certain embodiments a method and system to analyze the content of a packed bag utilizing a scanner is provided. The bag is scanned for a scannable characteristic to acquire scan data representative of a content of the piece of baggage. A volumetric data set is generated from the scan data, wherein the volumetric data set includes voxel values of the scannable characteristic throughout a volume of interest in the baggage. A rendered view is produced of the content of the piece of baggage based on the voxel values within a selected range from the volumetric data set. The method and system also provide identifying a threat by determining a Hounsfield value of the material of interest having a value close to that of explosives.

### BRIEF DESCRIPTION OF THE DRAWINGS

FIG. 1 illustrates a block diagram of a baggage inspection system with local screener's workstations formed in accordance with an embodiment of the invention.

FIG. 2 illustrates a Transport Layer Security (TLS) communication link between and local screener's TeleInspection Client (TIC) and a remote expert's TIC formed in accordance with an embodiment of the invention.

FIG. 3 illustrates a diagram representing a local screener workstation joined with a CT baggage and airport cargo inspection system as utilized in accordance with an embodiment of the invention.

FIG. 4 illustrates a plurality of screen shots for a display at a local screener's terminal containing an exemplary data set of scanned images formed in accordance with an embodiment of the invention.

FIG. 5 illustrates a screen shot for a display at a local screener's terminal containing a data set of scanned images of a suitcase and a radio containing simulated explosives show in FIG. 5 formed in accordance with an embodiment of the invention.

FIG. 6 illustrates a display as shown on a local screener's workstation formed in accordance with an embodiment of the invention.

FIG. 7 illustrates a display as shown in FIG. 6 that provides a user interface, a volumetric view, a horizontal view, and a vertical view formed in accordance with an embodiment of the invention.

FIG. 8 illustrates a flow chart for an exemplary sequence of operations carried out by a scanner to electronically unpack a piece of baggage performed in accordance with an embodiment of the invention.

FIG. 9 illustrates the relationship between a set of original coordinates and a new coordinate system utilized in accordance with an embodiment of the invention.

FIG. 10 illustrates electronic unpacking of an object utilizing surface rendering (SR) formed in accordance with an embodiment of the invention.

FIG. 11 illustrates electronic unpacking of an object utilizing volume rendering (VR) formed in accordance with an embodiment of the invention.

FIG. 12 illustrates electronic unpacking of an object utilizing maximum intensity projection (MIP) formed in accordance with an embodiment of the invention.

FIG. 13 illustrates a TeleInspection system formed in accordance with an embodiment of the invention.

### DETAILED DESCRIPTION OF THE INVENTION

An electronic unpacking process and system are provided that simulates physical unpacking of packed bags to visualize various objects within the bag, where the objects may represent threats. The electronic unpacking begins by generating a three-dimensional (3-D) data set of the packed bag utilizing, for example, the computed tomography (CT) scanners currently available. A screener or operator upon scrolling through slices of the 3-D data set would examine separate CT slices and decide whether an object that may be a threat is present or not. Typically, one piece of baggage is divided into hundreds of slices or images that are viewed for a complete screen.

Electronic unpacking utilizes the same CT data set to electronically unpack the same identical bag by performing a slice-by-slice processing. First, the 3-D computed tomography data may be interpolated to generate isotropic volume data. Just as there are many ways to unpack real physical bags, electronic unpacking offers a number of different visualization techniques/algorithms to visualize the objects within the packed bags. For instance, the bag may be electronically unpacked in 3-D using surface rendering (SR), volume rendering (VR), maximum intensity projection (MIP), or a combination thereof. The unpacking process may be used to visualize organic material (e.g., typical bombs) or metals (e.g., guns, knifes, and the like) for detection of certain threats while unpacking the bag.

Optionally, a 3-D threat detection algorithm may be provided to detect possible threats. The electronic unpacking and threat detection enhance both the threat detection accuracy and the image quality of the electronically unpacked bag. The bags that are automatically flagged by the threat detection algorithm are sent, along with images of the electronically unpacked bag clearly marked with threats, to a local screener who carefully inspects the images.

The electronic unpacking is superior to manual unpacking, in terms of bag throughput, as the electronic unpacking may be performed within the time that it takes to take the bag from the conveyor and to place the bag on a table for manual unpacking by a local screener. In addition, unlike manual unpacking, the electronic unpacking can identify whether various objects within the bag are innocuous or not, based on the Hounsfield Unit (HU). Moreover, electronic unpacking can determine the exact volume of all objects, both threats and innocuous, within the packed bag.

In accordance with certain embodiments, an electronic unpacking system seamlessly integrates with both the currently deployed and future generation computed tomography (CT) scanners as well as current and future generation explosives detection systems (EDS), while allowing a desired allocation of expert screening capabilities and remote monitoring of the inspection process itself. The electronic unpacking system integrates the EDS at all installations (e.g., airports, seaports, buses, trains, and the like) and all expert (and otherwise) screeners via a secure network. The system also integrates other orthogonal sensors (e.g., ETD) and the passenger information database. The system provides an expert-on-demand (EoD) service, through which, a local inexperienced screener at a particular EDS site, has instant access to remote screening experts located anywhere in the world. The system also allows real-time remote monitoring of the inspection process for each and every EDS site, enabling supervisors and government personnel to continually improve the inspection process. The monitoring capability may be used to log and store an inspection process that can be analyzed at a later date for various performance studies.

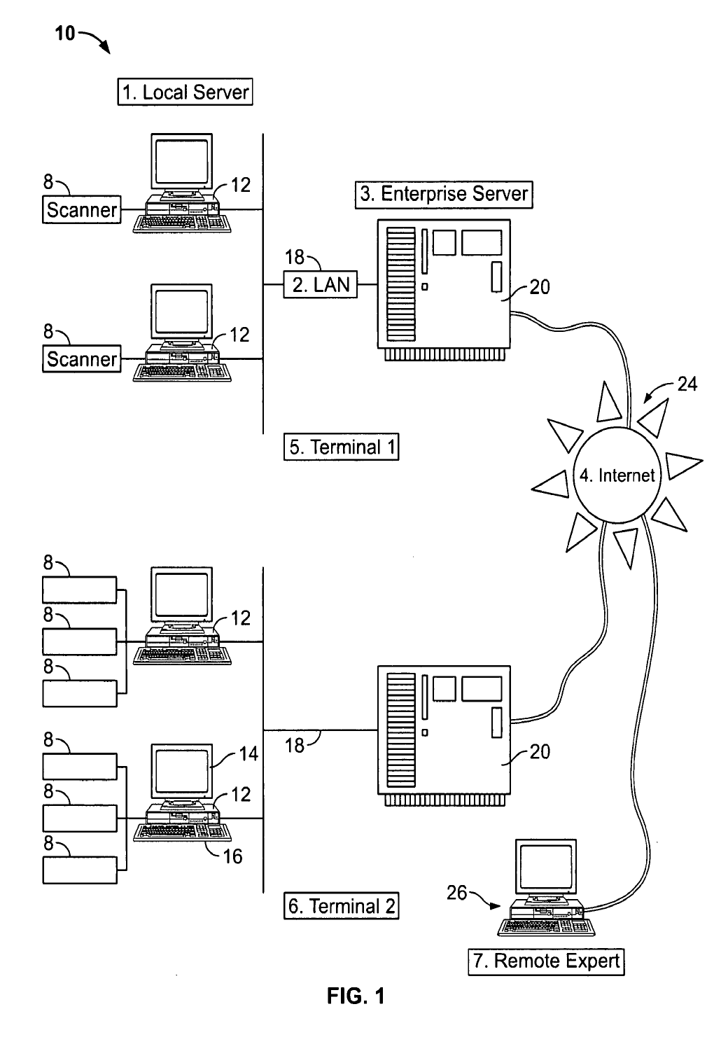

FIG. 1 illustrates a block diagram of a remote access security network 10 that implements electronic unpacking and threat detection in accordance with embodiments of the invention. The network 10 is joined to multiple image capture or scanner devices 8 (e.g., a CT scanner, a cine computed tomography scanner, a helical CT scanner, a four-dimensional (4D) cine computed tomography scanner, an electronic beam scanner, a DI scanner, an X-ray scanner, a dual-energy x-ray scanner, dual-energy CT scanner, and the like). Each scanner device 8 is located in an area under restricted access, such as: i) an airport terminal or concourse where passengers enter and leave; ii) a non-public area in the airport where the checked baggage is conveyed to airport employees for loading onto the airplanes. Other examples of areas under restricted access are office buildings, government buildings, court buildings, museums, monuments, sporting events, stadiums, concerts, convention centers, and the like.

Each scanner device 8 includes a scanner source and detector that are capable of obtaining a volumetric (or a cross-sectional) scan of each item of interest, a controller module to control operation of the scanner device, a user interface to afford operator control, and a monitor to display images obtained by the scanner. For example, the scanner and detector may rotate about the baggage as the baggage is conveyed along a belt (e.g., to perform a helical scan). The scanner device 8 communicates bi-directionally with a local terminal/server 12 that is configured to, among other things, operate as a local server. The scanning device 8 scans objects of interest, such as baggage (e.g. luggage, backpacks, briefcases, purses, and the like) to obtain volumetric data set representative of every voxel within the object of interest. The scanning device 8 conveys the volumetric data set for each piece of baggage to the local terminal 12. The local terminal 12 (or a local workstation) is configured to perform electronic unpacking and/or threat detection in real-time as a bag is conveyed along the belt. The local terminal 12 captures scan data in real-time and stores the scan data in local memory as the 3D volumetric data set, such as on the hard drive of the local terminal 12. The local terminal 12 includes a monitor 14 to display the volumetric and 2D images in real-time as an object is passing through the scanner device 8. The local terminal 12 also includes a user interface 16 to provide an operator control over the local terminal 12 and scanner device 8. Optionally, a single local terminal 12 may be connected to one or more nearby scanner devices 8 that are located in close proximity to one another, so that each operator can have access to the console of the local terminal 12. Optionally, a local terminal may be a local workstation that may produce a rendered view or may be connected to multiple display terminals to show the rendered view. The rendered views are pre-sorted and stored as a sequence of images. In an embodiment, the workstation communicates with a plurality of other processors and local workstations over a high-speed connection to display the rendered view.

The volumetric data set is sent from the local terminal 12 over a private communications link, such as a local area network (LAN) 18, to an enterprise server 20. The transfer of the volumetric data set may be initiated independently by the local terminal 12 or under the command of the enterprise server 20. The scan data is conveyed to the enterprise server 20 substantially in real-time. The term “real-time” as used through out this document shall include the time period while the object being scanned is still within the scanner device 8, and shall also include a period of time immediately after the object exits the scanning device 8 while the object is still within the restricted access area. For example, “real-time” would include the time from when a bag is checked up, the time in which the bag is transported to the flight, the time in flight, and the time in which the bag is transported from the flight to the bag retrieval area at the destination airport. In the example of a government building, “real-time” would include the time from when the object first enters the building until the object is carried out of the building. In the example of a live event, “real-time” would include the time from when the object enters the event area (e.g., fair ground, stadium, etc.) up until the object leaves the event area.

FIG. 1 shows more than one enterprise server (ES) 20, and each enterprise server 20 is connected to multiple local terminals 12. For example, one enterprise server 20 may be provided for each restricted access area (e.g., one ES per airport terminal, one ES per airport concourse, one ES per museum, one ES per government building). Alternatively, one enterprise server 20 may be service multiple restricted access areas, depending upon the geographic proximity of the restricted access areas and the form of communications link maintained between the local terminals 12 and the enterprise server 20.

The scan data is conveyed from the local terminals 12 to the ES 20 in one of several image formats (e.g., DICONDE, TIFF, JPEG, PDF, etc.). Each image file is assigned a header that identifies which scanner device 8 produced the image, the time of the scan, the passenger ID, and other data obtained at the point of scan. The image files are stored for 48 hours or more depending on the needs of the restricted access area.

The enterprise server 20 is connected, through a high-speed connection 24 (e.g., the internet, a private network, etc.), to multiple remote terminals 26 that may be used by experts in a manner explained hereafter. The enterprise server 20 and/or remote terminals 26 (as well as local terminals 12) are configured to perform electronic unpacking and threat detection in accordance with various techniques described thereafter. The enterprise server 20 performs numerous operations, such as responding to inquiries for specific scan data. The inquires may come from a remote terminal 26 over the high-speed connection 24 or from another local terminal 12 over the LAN 18. The enterprise server 20 obtains the requested data sets from memory, compresses and encrypts the data sets and sends the compressed data sets in a compressed, encrypted manner to the requesting remote terminal 26 or local terminal 12. The compressed data sets are conveyed with a standard internet transport protocols. By way of example, an enterprise server may service all of the local terminals 12 in a single large airport terminal building, or the entire airport for medium-size, and smaller airports. A larger airport such as Los Angeles International airport (LAX) or John F. Kennedy International airport (JFK) may have several enterprise servers 20, corresponding to the different terminal buildings at their respective locations. Various functions of ES can also be distributed to local terminals 12.

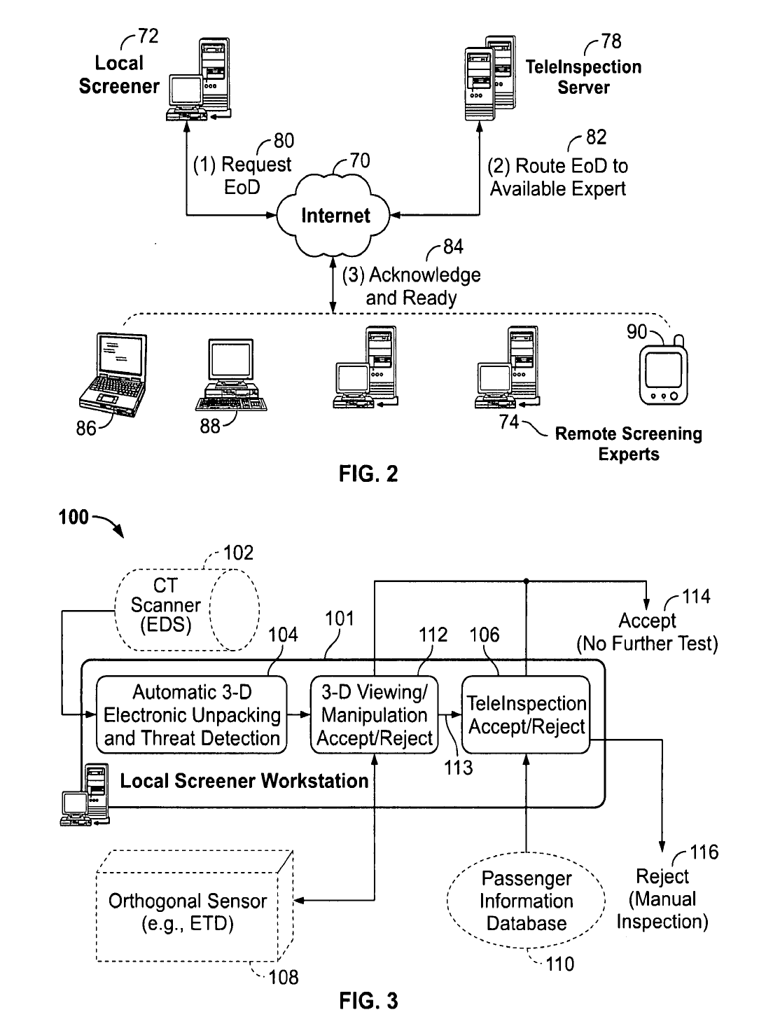

Upon review of the 3-D electronically unpacked bag images, the local screener 72 has the option to either accept the bag or request consultation with one or more remote screening experts 74 using the expert-on-demand (EoD) service (as shown in FIG. 2).

FIG. 2 shows a system architecture that illustrates a sequence of events to establish a Transport Layer Security (TLS) (TLS) communication link 70. A TLS link 70 is established when a local screener 72 wants to consult a remote expert 74. Both the local screener 72 and the remote expert 74 run an instance of a TeleInspection Client (TIC). The TIC communicates via the Internet to a TeleInspection Server (TIS) 78. TIS 78 continuously monitors the status of the local workstation and all remote display terminals. The local screener 72 TIC communicates with the remote expert's 74 TIC via the internet and through the TIS 78.

The sequence begins by the local screener 72, using a local workstation to request Expert-on-Demand (EoD) service through a TeleInspection Server by using a local instance of TeleInspection Client (TIC). The TIC may have a list of preferred experts. The user clicks an EoD button (not shown) on the local screener's 72 TIC window to request 80 the expert-on-demand (EoD) service. The request 80 is received by the central TIS 78, which routes 82 the EoD request to the next available remote screening expert 74. The EoD request 80 is acknowledged 84 by the currently available remote expert 74, and the EoD request 80 is serviced by the first available remote screening expert 74. Upon completion of this sequence, a direct TLS link 70 from the screening expert's 74 TIC to the local screener's 72 TIC is established

The local screener 72, through the local screener TIC, and the expert screener 74, through the expert screener TIC, is able to view and manipulate the 3-D images of unpacked bags through a TeleInspection View Sharing (TVS) protocol built into the TIC. The communication between the local screener 72 and the remote expert 74 is similar to public domain messenger services such as MSN®, AOL® and Yahoo® messengers. However, the TeleInspection system is specially developed for security applications with careful considerations of airport inspection process and EDS requirements. Therefore, users or public messenger services are unable to establish a link with expert screeners 74.

The system architecture allows remote experts 74 to be off-site by using instances of the TIC anywhere in the world. A remote expert 74, thus, may be off-site with a laptop computer 86, at home with a PC 88 or on the road with a PDA 90. The TIC supports transmitting text, voice, video, white board, and the like. Various passenger information data, such as passenger itinerary, travel history, credit information, passenger profile, passport information, passenger photograph, family history, age, physical characteristics, job information and the like are also available for review to assist in the decision whether to accept or reject the suspect bag. Other screeners and experts (not shown) running instances of TICs, may be invited to join an on-going conference.

The existence of the TIS is transparent to all users of TICs. From the viewpoint of the local screener 72, the conference begins at the click of the EoD button (not shown) and the conference begins from the viewpoint of the remote expert 74 at the click of the Acknowledge button (not shown) on the expert's 74 TIC windows. Thus, one remote expert 74 is able to provide service to a number of different EDS sites. The number of false-positives at each EDS site is reduced by the availability of remote screening experts 74; for, the remote experts 74 appear to an outside observer as being locally stationed with each and every EDS site that utilizes a remote expert 74. The TeleInspection system improves the performance of each EDS by effectively sharing expert screeners 74 and allowing the expert screeners 74 to be located anywhere in the world.

FIG. 3 illustrates a diagram 100 representing a local screener workstation 101 utilized in conjunction with a CT baggage and airport cargo inspection system. The workstation 101 is configured to perform electronic unpacking. An electronic unpacking operation starts with the CT image volumetric data set provided by a CT scanner 102. The local inspection is performed via the 3-D electronic unpacking and threat detection algorithms 104 followed by the TeleInspection system 106. The system maybe integrated with existing orthogonal sensors 108 (e.g., ETD) as well as a passenger information database 110.

As the scan data becomes available from the CT scanner 102, a 3-D electronic unpacking module 104 unpacks the 3-D bag electronically and generates inside views of the unpacked bag with clearly marked threats in 3-D. If there are no threats automatically detected, the bag is accepted 114. If the bag is not accepted, the flow continues along 113, because potential threats are displayed, the 3-D images with clearly marked threats are passed onto the local screener 72 who visually inspect the 3-D images. The local screener 72 can either accept the bag 114 or request assistance via the expert-on-demand (EoD) service of the TeleInspection system 106. The TeleInspection system 106 provides a secure communication link (shown in FIG. 2) using a set of media including text, voice, video as well as passenger information data. Upon the EoD service request, a conference between the local screener 72 and the remote expert 74 is initiated to decide whether or not to accept the bag. The local screener 72 along with one or more remote experts 74 and/or supervisors can simultaneously observe and manipulate (e.g., rotate, zoom, etc.) the 3-D views of electronically unpacked bag for resolution of the suspect bag. During the conference, other relevant data including passenger information such as whether the passenger is a frequent flyer, the passenger's destination/origin, and the like are utilized to determine the likelihood of a threat. Thus, the overall performance of an EDS system may improve as remote screening experts 74 are used. Each remote screening expert 74 brings technical skill, knowledge, and years of experience to assist the local screener 72 to determine whether the bag has any potential threats. The remote experts 74 are able to assist in lower the false alarm rate without missing any potential threats.

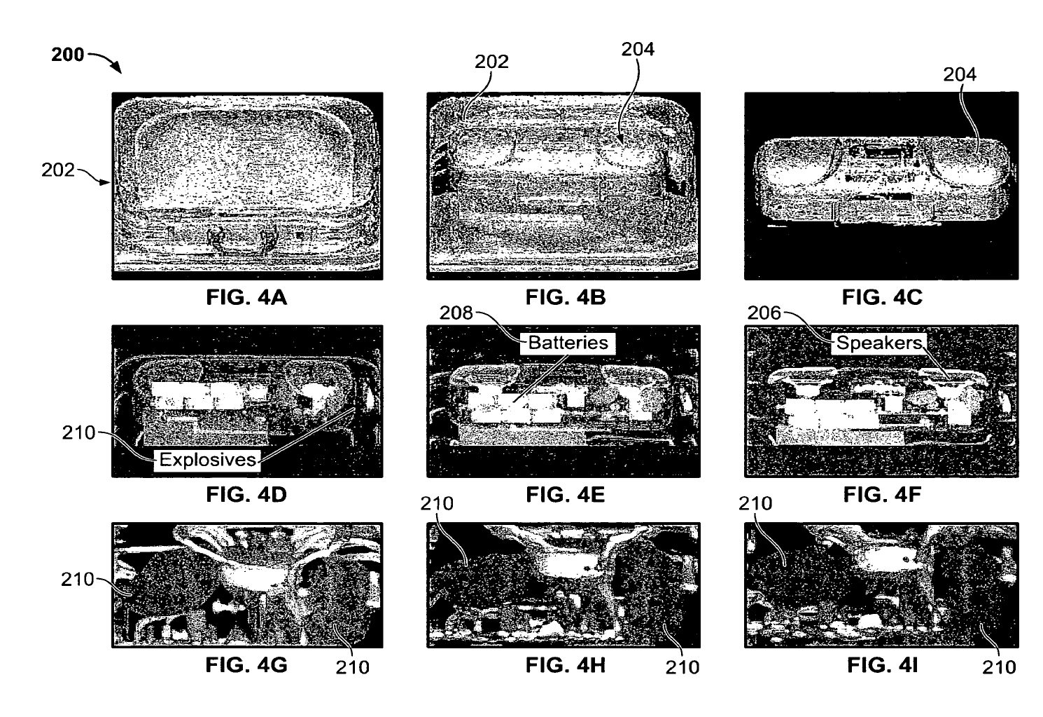

FIG. 4 illustrates an exemplary process for electronic unpacking 200 of a piece of luggage. The unpacking begins with a surface rendering of the entire bag 202 as shown in FIG. 4(a). The initial surface rendering with a portion of the bag 202 peeled (i.e., unpacked) shows the radio 204 packed within the bag 202 as shown in FIG. 4(b). The surface rendering of the radio 202 is shown in FIG. 4(c). To view a structure within the radio 202, the CT data is volume rendered with color transparencies as shown in FIGS. 4(d), 4(e), and 4(f). Clearly visible due to the different transparencies for different objects are two speakers 206, a pack of batteries 208, and two six-ounce explosive stimulants 210 (e.g. as soap bars) that are hidden underneath the right speaker. The detected explosives 210 will be clearly marked for the local screener's 72 benefit as shown in FIG. 4(g). The views (e.g., FIGS. 4(d) through 4(f)) can be displayed in a continuous 3-D display that rotates for the local screener 72 to examine. Finally, the local screener 72 may want to zoom in on the possible explosive stimulants 210 underneath the right speaker 206 as shown in FIGS. 4(g), 4(h), and 4(i).

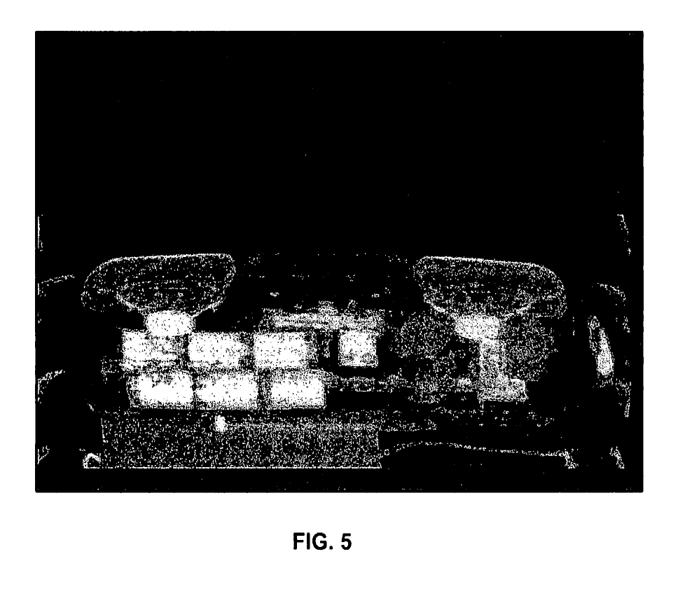

FIG. 5 illustrates a high resolution 3-D view of the image of the radio 204 (shown in FIG. 4(e)). In an exemplary embodiment, the 3-D views (shown in FIG. 4) may be in color and the detected explosives may be displayed in a shade of orange with an ellipsoid surrounding the explosives. The local screener 72 is able to rotate, zoom and localize these 3-D views as necessary, with or without the assistance of a remote expert 74 in resolving the suspect bag. In addition, the local screener 72 may also utilize some measurement tools (e.g., such as distance/volume) to determine whether an object is a threat.

Running parallel to the electronic unpacking process 104 (as shown in FIG. 3), a threat detection algorithm is also executed. During electronic unpacking 104, the surface rendering 303 and volume rendering 304 process (described below) visit all the voxels within the 3-D dataset, where each voxel is classified into one of several categories, such as innocuous, organic, steel, and the like. The voxel is categorized based on the Hounsfield unit value of the voxel. Low Hounsfield unit values correspond to voxels for air or water and are classified as innocuous; medium Hounsfield unit values correspond to voxels classified as organic material (e.g., shampoo or explosives); and high Hounsfield unit values correspond to voxels classified as aluminum or steel (e.g., for guns or knives). Once the classification marking is completed and 3-D views are generated. The volume data is initially segmented by determining the edges and borders of an object by connecting together voxels having similar Hounsfield unit values in common. For example, the voxels are connected together using a 3-D connectivity algorithm as known in the art, such as the marching-cubes algorithm or a 3-D region growing algorithm. Furthermore, by taking the average of each of the connected voxels and utilizing a known smoothing algorithm a surface is provided

Upon completion of the segmentation, the volume rendered 304 images are compared against the segmented regions for consistency, and the initial segmentation is modified in accordance. The rendered views are generated using a portion of the 3-D data to render a particular object (e.g., the threat) or objects within the packed bad, and to discard obstructing structures to clearly render the object of interest (e.g., the threat). Once the final segmentation is completed, the detected threat objects are automatically indicated with ellipsoids on the 3-D rendered images for the local screener. By combining volume rendering 304 with segmentation, the threats (e.g., explosive stimulants) are clearly visible and identified, and the via the consistency check the detection accuracy is improved and the false-alarm rate is lowered. The rendered views of the threats may be shared across a network.

Both the 3-D electronic unpacking 104 and threat detection are executed in real-time and will be completed by the time the data for the next bag becomes available. Alternatively, the workstation 101 can be augmented with staggered computer processing units (CPUs) for meeting throughput requirements for future improved threat detection algorithms that may require more processing requirements.

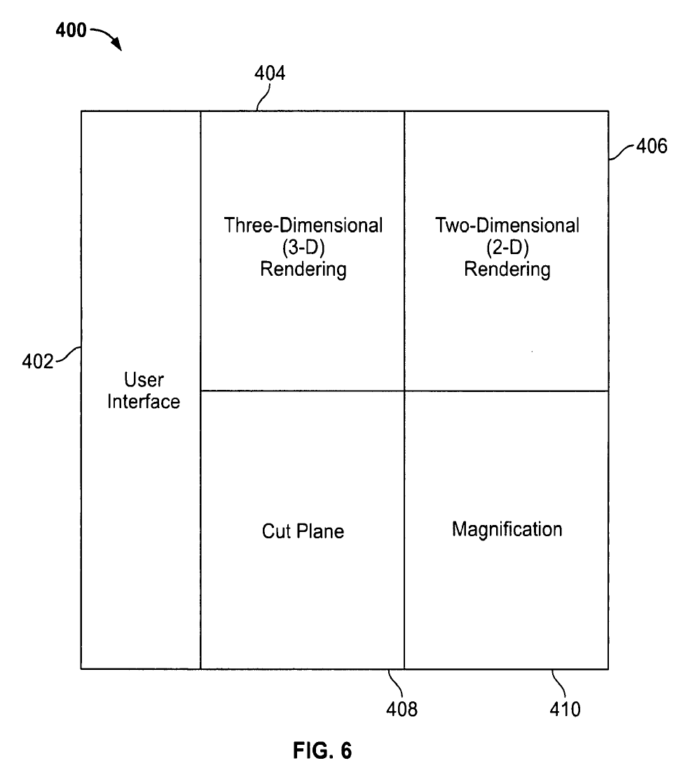

FIG. 6 illustrates an embodiment of a display 400 as shown on a local screener's 72 workstation. The display 400 provides a user interface 402, a three-dimensional (3-D) rendering window 404, a two-dimensional (2-D) rendering window 406, a cut plane window 408, and magnification window 410. In an alternative embodiment, additional windows may be provided to display various angles, perspectives, rotations, magnifications of an object.

The user interface 402 may include scroll bar or buttons (e.g., up-button down-button, left-button, right-button, and the like) to facilitate selection of a region of interest in the object. Alternatively, the user can utilize a drawing function to trace, to sketch, or to outline around the area of interest. The user interface 402 may allow a user to toggle-on and toggle-off various portions of the display portions (e.g., 3-D rendering window or 2-D rendering window). If a display portion is not shown, the remaining portion may be re-sized and/or rotated. For example, the object displayed in any of the windows can be rotated about at least two axes, typically a vertical axis and one or both horizontal axes. The user interface 402 also allows the user to measure a plurality of distances and save each distance in memory. The distances may include a length, a diameter, a radius, and the like. The distances can be utilized to determine a volume of an object. Further, user interface 402 provides a variety of markers for the user to identify potential areas of interest, cut-out specific sections or cut-out specific portions of an object, and to identify threats.

The 3-D rendering window 404 provides a volumetric view of the object. By utilizing a rotation function provided by user interface 402, the volumetric view is rotatable in 360 degrees. The 2-D rendering window 406 provides a cross-sectional view of the object or of a region of interest as selected by the user via the user interface 402. The 3-D rendered window 404 and the 2-D rendered window 406 are related to one another and based on a common region of interest. For instance, both the 2-D rendering window 406 and the 3-D rendering window 404 provide interactive 2-D. Furthermore, both displays allow a selected portion of the object to be magnified and rotatable.

The cut-plane window 408 allows a variety of planes through the object to be displayed, such as horizontal, vertical, transverse, and other planes at various angles (e.g., saggital, coronal and axial planes). For instance, the user may select a singular planar section, two sections, four sections, six sections, or eight sections to be displayed in cut-plane window 408. Each plane is selectably rotatable in 360 degrees. Further, as the region of interest shown in the 3-D rendered window 404 and 2-D rendered window 406 is updated, changed, or reconfigured, the plane(s) shown in cut-plane window 408 are interactively updated.

The magnification window 410 displays a region of interest and allows the user to magnify a selected region of interest by depressing a button located on the user interface 402 (e.g. a mouse button, a touch screen button, a trackball button, and the like). Further, the user has the ability to select the amount of magnification ranging from approximately 0.1× to 100×.

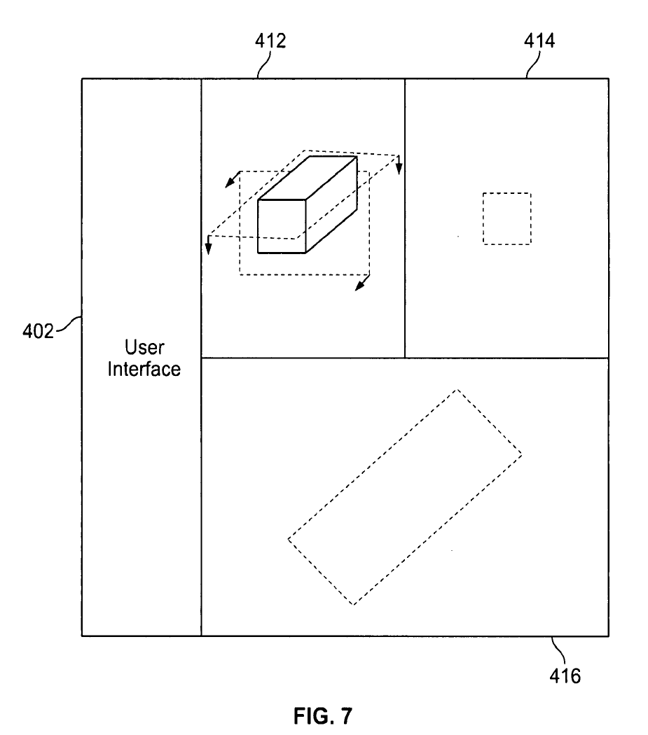

FIG. 7 illustrates a further embodiment of a display 400 that shows the user interface 402, as well as a volumetric view 412, a horizontal view 416 and a vertical view 414. The user is able to select a particular planar slice from the volumetric view 412. For instance a horizontal slice or a vertical slice may be selected. Multiple slices may also be selected. The slice thickness will be solely dependent upon the acquired CT data set. If a horizontal slice is selected, the slice is displayed in horizontal view 416. Similarly, if a vertical slice is selected, the slice is displayed in vertical view 414. The slices in horizontal view 414 and vertical view 416 are rotatable and magnifiable, as discussed above.

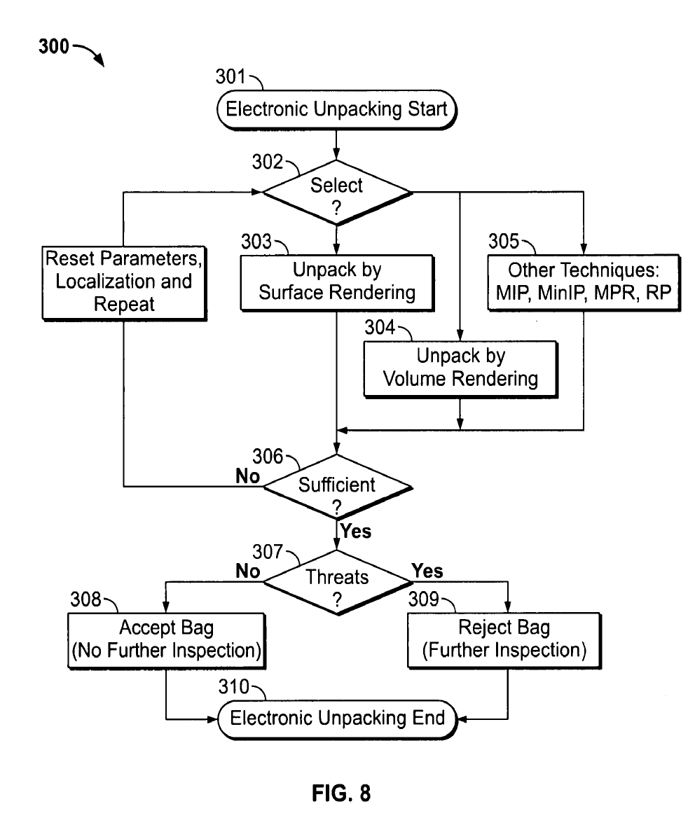

FIG. 8 illustrates a flow diagram 300 depicting the process of electronically unpacking a bag. At 301, electronic unpacking 101 starts as soon as the CT slice images of the scanned bag become available. The X-ray CT scanner provides samples of a linear attenuation coefficient, denoted as μ(x, y, z). The measurements are taken as samples of μ(x, y, z) and the sampling locations are denoted as:
{xₚ}ₚ₌₀^{N}^{ₓ}⁻¹, {y_{q}}_{q=0}^{N}^{_{y}}⁻¹, and {zₖ}ₖ₌₀^{N}^{_{z}}⁻¹ (1)
where Nₓ×N_{y}×N_{z} in equation (1) denotes the number of voxels available in the 3-D data. The CT scanner scans a piece of baggage for a scannable characteristic to acquire scan data representative of a content of the piece of baggage, wherein the scannable characteristic is an attenuation measurement. The CT scanner provides axial slices (or z-slices) with isotropic pixels, where xₚ=p Δx, and y_{q}=q Δy, and Δx=Δy. However, as the slice spacing of axial cuts may be different from the pixel size and may actually vary even within a single 3-D data set, the arbitrary slice spacing, shown below in equation (2), may be assumed:
{zₖ}ₖ₌₀^{N}^{_{z}}⁻¹={zₒ, z₁, z₂, . . . , z_{N}_{_{z}}₋₁} (2)

Thus, assuming the data to be corrupted by additive noise, the equation (3) is a model of the measured 3-D data set:
ƒ(xₚ, y_{q}, zₖ)=μ(xₚ, y_{q}, zₖ)+n(xₚ, y_{q}, zₖ) (3)

The 3-D non-isotropic data set must be interpolated across the z-axis 312 to generate an isotropic 3-D data set. The exact interpolation may be performed on the 3-D data using Shannon's interpolation formula (i.e., also known as Whittaker-Shannon interpolation formula). The interpolation may also be implemented using fast Fourier transforms (FFT) with zero padding if the slice spacing does not change within the 3-D data set; however, the size of the required FFT may be too large to be implemented on a general purpose computer. A general solution for the arbitrary slice spacing given in equation (2) must utilize Shannon's original interpolation formula or at least the sub-optimal approximation to Shannon's interpolation formula. However, conventionally the following linear interpolation 321 shown in equation (4) is used:

$${f}_{INT} ( x , y , z ) = ( 1 - \frac{z - {z}_{k}}{{z}_{k + 1} - {z}_{k}} ) f ( x , y , {z}_{k} ) + \frac{z - {z}_{k}}{{z}_{k + 1} - {z}_{k}} f ( x , y , {z}_{k + 1} ) , {z}_{k} \leq z \leq {z}_{k + 1} \qquad ( 4 )$$

Although the above technique is a linear interpolation across z-slices 312, any other interpolation method may also be used. The isotropic volume data of the specimen that can be visualized in 3-D results upon interpolation of the 3-D CT data. Thus, a volumetric data set is generated from the scan data, where the volumetric data set includes voxel values that are in Hounsfield units, for the scannable characteristic throughout a volume of interest in the piece of baggage. A portion of the volumetric data set is segmented based on the voxel values to identify an object and provide a visual marker outlining the object. The voxel values are segmented into categories. The categories are selected by the Hounsfield unit value of the voxel, and the categories being an innocuous material, an organic material and a metallic material.

At 202, depending on the type of bag and/or the screener's 72 preference, a visualization technique is selected. A variety of visualization techniques may be utilized to render the isotropic volume data in 3-D. Furthermore, the visualization technique may be selected automatically depending on the size of the bag and the density distribution of objects inside the bag. Depending on which visualization technique selected by the screener 72, the electronic unpacking renders the scanned bag data using surface rendering (SR) 303, volume rendering (VR) 304, or maximum intensity projection (MIP) 305. Alternatively, minimum intensity projection (MinIP), multi-planar reformatting (MPR), or radiographic projection (RP) may also be utilized in place of MIP to visualize the 3-D results. The selected visualization technique produces a rendered view of the content of the piece of baggage based on voxel values within a selected range from the volumetric data set. The rendered view is produced from voxel values that lie within a user selected range of thresholds of a selectable range of voxel values wherein the user has the ability to interactively adjust the selectable range.

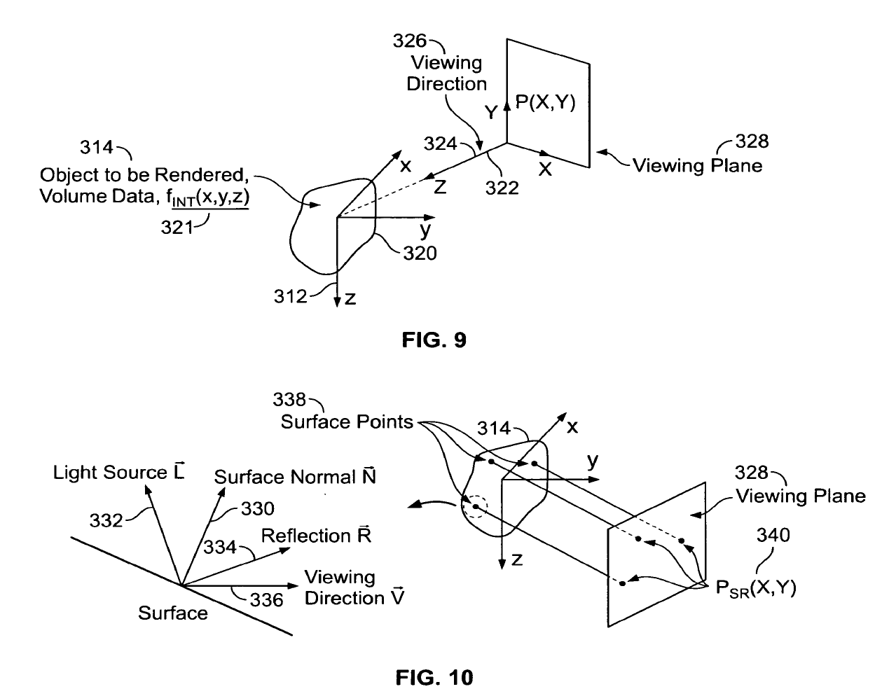

FIG. 9 illustrates the relationship between original coordinate (x,y,z) 320 and a new coordinate (X,Y,Z) 322 that is introduced to explain the various visualization methods. The direction of the Z-axis 324 is parallel to the viewing direction 326, so the viewing plane 328 is perpendicular to the Z-axis 324.

Surface Rendering (SR) 203 is a visualization that is utilized to unpack a bag to show the exterior surface of objects within the packed bag. But, before the actual visualization step occurs, SR 203 requires the volume data to be preprocessed, i.e., a surface extraction is performed to determine the exterior surface of an object. In general, surface boundary voxels are determined using a threshold value from the isotropic volume data. Then a marching cube algorithm or a marching voxel algorithm is applied to the surface boundary voxels, which provides the surface data of the object.

After surface extraction, the object is rendered in 3-D using a light source 332 and a reflection 334 resulting from the light source 332. There are three types of reflection, i.e., diffuse, specular, and ambient reflections.

FIG. 10 illustrates a plurality of unit vectors that are related to the diffuse, specular, and ambient reflections. The diffuse reflection is determined from an inner product between a surface normal \vec{N} vector 330 and a light source direction \vec{L} vector 332. Although the viewing direction 326 (shown in FIG. 9) is changed, the diffuse reflection will remain unchanged. On the other hand, a specular reflection is determined from a plurality of n powers of an inner product between a light reflection direction \vec{R} vector 334 and a viewing direction \vec{V} vector 336. Thus, the specular reflection will be changed according to the change of the viewing direction 326. The ambient reflection is caused by the ambient light source, which is assumed as to affect a specific space uniformly without a specific direction.

An object is represented by the sum of the diffuse, specular, and ambient reflections. If the unit vectors on the surface points 338 of the object are denoted to correspond to the viewing plane points (X,Y) 328 as \vec{L}(X,Y), \vec{N}(X,Y), \vec{R}(X,Y) and \vec{V}(X,Y). The resulting surface-rendered image P_{SR}(X,Y) 340 can be expressed by equation (5) as:
P_{SR}(X,Y)=I{K_{diff}(\vec{L}(X,Y)·\vec{N}(X,Y)+K_{spec}(\vec{V}(X,Y)·\vec{R}(X,Y))ⁿ}+A (5)

As shown in equation (5), K_{diff} and K_{spec} are the coefficients that control the ratio of diffuse and specular reflections, and I is the intensity of the light source from a specific direction \vec{L}. The constant A denotes the ambient reflection by the ambient light source in a specific space. The inner product values are in the range between zero and unity.

SR 303 handles only surface data of the object after surface extraction, so the surface rendering speed is higher than the other visualization techniques. SR 303 is very good for various texture effects, but SR 303 needs preprocessing of volume data such as surface extraction. Therefore, SR 303 is not suitable for thin and detailed objects as well as that object that have a transparent effect.

On the other hand, Volume Rendering (VR) 304 is a visualization technique that uses volume data directly without preprocessing of the volume data, such as required by surface extraction in SR 303. A characteristic aspect of VR 304 is opacity 342 and color 344 (shown in FIG. 10) that are determined from the voxel intensities and threshold values. The opacity 342 can have a value between zero and unity, so the opacities 342 of the voxels render multiple objects simultaneously via a transparent effect. Thus, for example, surface rendering 303 is an extension of volume rendering 304 with an opacity 342 equal to one. The colors 344 of voxels are used to distinguish the kinds of objects to be rendered simultaneously. Using opacities 342 and colors 344 of voxels, the objects are rendered in 3-D by a composite ray-tracing algorithm. But, the viewing direction 326 can be changed, so the voxel intensities must be re-sampled according to the viewing direction 326 at the new voxel locations in the new coordinate (X,Y,Z) 322 before ray tracing is performed. The volume data in coordinate (X, Y, Z) 322 can be denoted as \hat{ƒ}_{INT}(X,Y,Z) 321.

While the rays traverse the voxels, the pixel values are computed from the opacities 342 and colors 344. The composite ray-tracing algorithm used in VR 304 is based on the theory of physics of light transportation in the case of neglecting scattering and frequency effects. Given an emission q and an absorption κ along a ray s, an intensity I can be computed from the following equation (6):

$$I ( s ) = {\int }_{{s}_{0}}^{s} q ( {s}^{′} ) {ⅇ}^{- {\int }_{{s}_{0}}^{{s}^{′}} κ ( {s}^{″} ) ⅆ {s}^{″}} ⅆ {s}^{′} \qquad ( 6 )$$

that can be discretized as show in equation (7) below:

$$I = {\sum }_{k = 0}^{n - 1} q ( {s}_{0} + k Δ {s}^{′} ) {ⅇ}^{- {\sum }_{{k}^{′} = 0}^{k - 1} κ ( {s}_{0} + {k}^{′} Δ {s}^{″} )} = {\sum }_{k = 0}^{n - 1} q ( {s}_{0} + k Δ {s}^{′} ) {\prod }_{{k}^{′} = 0}^{k - 1} {ⅇ}^{- κ ( {s}_{0} + {k}^{′} Δ {s}^{″} )} \qquad ( 7 )$$

FIG. 11 illustrates a composite ray tracing algorithm that is used in VR 304. Associating equation (6) with VR's 304 ray-tracing algorithm, the emission q can be regarded as the colors 344 of voxels and the exponential term stands for the light transmission up to a local voxel. Thus, denoting opacity 342 and color 344 in coordinate (X,Y,Z) 322 as α(\hat{ƒ}_{INT}(X,Y,Z)) and c(\hat{ƒ}_{INT}(X,Y,Z)) with some modification of Equation (7), the volume-rendered 204 image P_{VR}(X,Y) 342 at one specific viewing direction, can be expressed as shown in equation (8):

$${P}_{VR} ( X , Y ) = {\sum }_{Z = 1}^{n} c ( {\hat{f}}_{INT} ( X , Y , Z ) ) α ( {\hat{f}}_{INT} ( X , Y , Z ) ) {\prod }_{{Z}^{′} = 0}^{Z - 1} \{ 1 - α ( {\hat{f}}_{INT} ( X , Y , {Z}^{′} ) \} . \qquad ( 8 )$$

VR 304 is known as a superb method for thin and detailed objects and suitable for good transparent effects. But VR 304 uses whole volume data, so the volume rendering speed is relatively low due to the expensive computation.

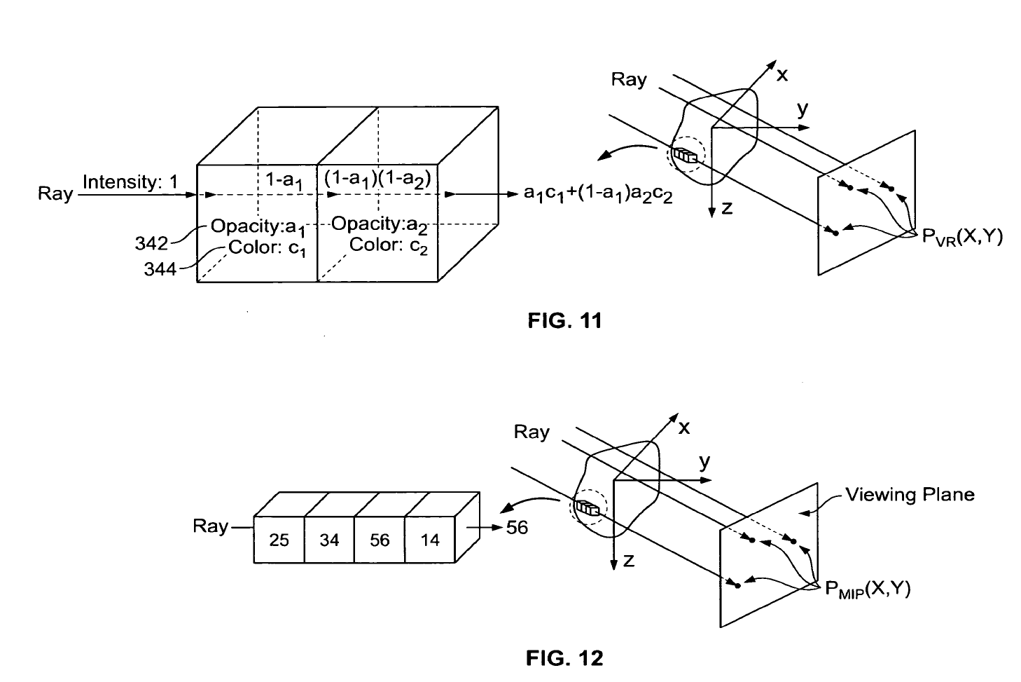

FIG. 12 illustrates a Maximum Intensity Projection (MIP) 305 which is a visualization technique that is realized by a simple ray-tracing algorithm. MIP 305 uses the intensity volume data directly without preprocessing of any volume data. The ray traverses the voxels and the only maximum voxel value is retained on the projection plane perpendicular to the ray.

Similar to VR 304, the resampling of voxel intensities at the new voxel locations according to the viewing direction is also needed before ray-tracing can be performed. The MIP 305 process can be expressed shown in equation (9):

$${P}_{MIP} ( X , Y ) = {max}_{Z} \{ {\hat{f}}_{INT} ( X , Y , Z ) \} . \qquad ( 9 )$$

The viewing direction 326 is in the direction of the Z-axis 324 and \hat{ƒ}_{INT}(X,Y,Z) 321 is the resampled voxel intensity at the new voxel location in the new coordinate (X,Y,Z) 328.

MIP 305 is a good visualization method, especially for vessel structures. But MIP 305 discards the information of depth while transforming 3-D data to 2-D data that results in an ambiguity of geometry of an object in the MIP 305 images. But, this ambiguity can be solved, for example, by showing MIP 305 images at several different angles in a short sequential movie.

At 306, if the rendered image is not sufficiently detailed enough to make the decision whether to accept or reject the bag, the unpacking process is repeated with a new set of rendering parameters. The new rendering parameters may include, for example, the opacity 342 and coloring 344 scheme for volume rendering 304 and lighting conditions for surface rendering 303, a new rendering region, orientation of the viewpoint, and the like. For instance, the rendered image as displayed to a local screener may simultaneously co-display at least one of a surface and volume rendered view of the content of the piece of baggage, and an enlarged image of a region of interest from the rendered view. The user may zoom on a region of interest within the rendered view or may rotate the rendered view to display the content of the piece of baggage from a new viewpoint.

At 307, the screener 72 must decide whether one or more threat objects exist within the packed bag. In an embodiment, an automatic threat detection analysis of at least a portion of the volumetric data set based on the scannable characteristic is performed. Based on screener's 72 experience, perhaps aided by a remote expert 74 through the Expert-on-Demand service of TeleInspection 78 (shown in FIG. 3), the decision is made whether to accept 308 or reject 309 the bag in question. At 310, once the final decision is made, the inspection completes and the screener 72 is presented with the next bag.

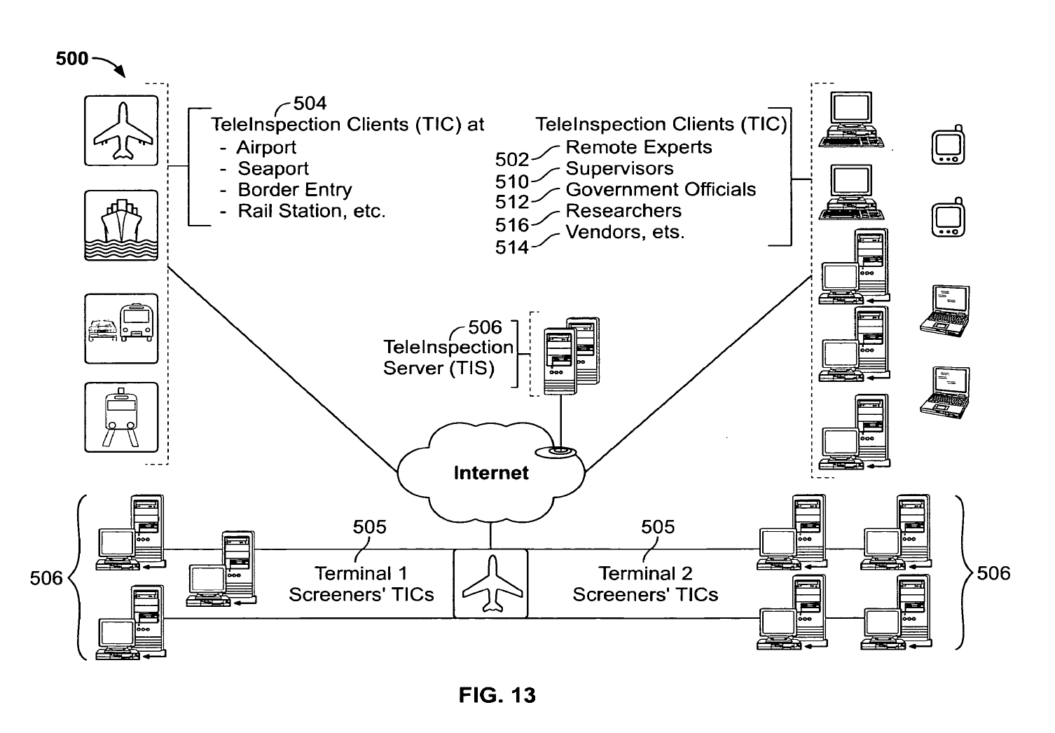

FIG. 13 illustrates an alternative embodiment of an expanded TeleInspection system 500 where the performance of each EDS site is enhanced by remote screening experts 502. For each CT (EDS) site, one workstation is deployed to perform the 3-D automatic threat detection and electronic unpacking for the initial screening of baggage. The TeleInspection Client 504 in the local workstation allows a local screener 505 to request the expert-on-demand (EoD) service to allow the local screener 505 to communicate to the first available remote expert 502. A centralized TeleInspection Server (TIS) 506 manages and directs all network communication. In one embodiment, all CT installations in terminals at all airports can be equipped with such workstations 506 for access to remote experts 502. Such a network architecture can be applied to connect all EDS sites to distribute the expert screeners 502 to all airports and seaports, and in fact, all facilities with EDS. Furthermore, the TeleInspection system 500 allows screening supervisors 510 to monitor the inspection process in real-time. In an alternative embodiment, the TeleInspection system 500 can easily be expanded to serve the entire nation (e.g., even the world) to network all facilities such as government buildings, and the like. Other users, with appropriate clearances, may also access the system. For instance, the system 500 can allow access for supervisors 510, government officials 512 (e.g., law enforcement), and vendors 514 among others. Other user groups who can access the system are independent researchers 516. Independent researchers 516 have access to 3-D bag data to continually enhance automatic detection algorithms, and vendors 514 have access to EDS for routine maintenance and/or real-time consultation.

In the above examples, the scanners are described in connection with CT and DI scanners and the data sets are described in connection with attenuation measurement data. For instance the scanners may include a cine computed tomography scanner, a helical CT scanner, a dual-energy x-ray scanner, dual-energy CT scanner, and a four-dimensional (4-D) cine computed tomography scan. However, alternatively other types of scanners and other types of data may be obtained, processed and displayed without departing from the meets and bounds of the present invention. For example, the scanner may represent an electron beam scanner. Alternatively, the scanner may transmit and receive non-x-ray forms of energy, such as electromagnetic waves, microwaves ultraviolet waves, ultrasound waves, radio frequency waves and the like. Similarly, in the above described embodiments, the data set is representative of attenuation measurements taken at various detector positions and projection angles, while the object is stationary within the scanner or while the object is continuously moving through the scanner (e.g., helical or spiral scanning). Alternatively, when non-x-ray forms of energy are used, the data set may represent non-attenuation characteristics of the object. For example, the data may represent an energy response or signature associated with the object and/or the content of the object, wherein different types of objects may exhibit unique energy responses or signatures. For example, explosives, biological agents, and other potentially threatening medium, may exhibit unique electromagnetic responses when exposed to certain fields, waves, pulse sequences and the like. The electromagnetic response of the object and the content of the object are recorded by the scanner as scan data. As a further example, the scanner may be used to obtain finger prints from the object. The finger prints would be recorded as scan data.

The modules discussed above in connection with various embodiments are illustrated conceptually as a collection of modules, but may be implemented utilizing any combination of dedicated hardware boards, digital signal processors (DSPs) and processors. Alternatively, the modules may be implemented utilizing an off-the-shelf PC with a single processor or multiple processors, with the functional operations distributed between the processors. As a further option, the modules may be implemented utilizing a hybrid configuration in which certain modular functions are performed utilizing dedicated hardware, while the remaining modular functions are performed utilizing an off-the shelf PC and the like.

While the invention has been described in terms of various specific embodiments, those skilled in the art will recognize that the invention can be practiced with modification within the spirit and scope of the claims.

What is claimed is:

1. A method to analyze a content of a packed bag, comprising:
scanning a piece of baggage for a scannable characteristic to acquire scan data representative of a content of the piece of baggage;
generating a volumetric data set from the scan data, the volumetric data set including voxel values for the scannable characteristic throughout a volume of interest in the piece of baggage; and
producing a rendered view of the content of the piece of baggage based on voxel values within a selected range from the volumetric data set.

2. The method of claim 1, wherein the scannable characteristic is an attenuation measurement and the voxel values are in Hounsfield units.

3. The method of claim 1, further comprising displaying a three-dimensional (3D) image as the rendered view.

4. The method of claim 1, wherein the producing performs at least one of a surface rendering, a volume rendering, a maximum intensity projection rendering, a minimum intensity projection rendering, a multi-planar reformatting, and a radiographic projection.

5. The method of claim 1, further comprising permitting a user to select a range of thresholds of selectable range for voxel values, the rendered view being produced only from voxel values that fall within the range.

6. The method of claim 1, further comprising permitting a user to interactively adjust the selectable range of voxel values to be utilized to produce the rendered view.

7. The method of claim 1, further comprising displaying, in real-time, the rendered view of the content of the piece of baggage based on an adjusted selectable range.

8. The method of claim 1, further comprising simultaneously displaying a surface rendered view and a volume rendered view of the content of the piece of baggage.

9. The method of claim 1, further comprising simultaneously co-displaying:
i) at least one of a surface and volume rendered view of the content of the piece of baggage; and
ii) an enlarged image of a region of interest based on the rendered view.

10. The method of claim 1, further comprising performing an automatic threat detection analysis of at least a portion of the volumetric data set based on the scannable characteristic.

11. The method of claim 1, further comprising segmenting at least a portion of the volumetric data set based on the voxel values to identify an object and providing a visual marker outlining the object based on the segmenting.

12. The method of claim 1, further comprising classifying the voxel values into one of a plurality of categories and segmenting the voxel values in at least one category.

13. The method of claim 1, further comprising zooming the rendered view in on a region of interest and displaying an enlarged image of the region of interest.

14. The method of claim 1, further comprising rotating the rendered view and displaying the content of the piece of baggage from a new viewpoint.

15. The method of claim 1, further comprising classifying the voxel values as at least one of an innocuous material, an organic material, and a metallic material based on a Hounsfield unit value.

16. The method of claim 1, wherein the rendered views are pre-generated and stored as a sequence of images.

17. The method of claim 1, wherein the rendered views are generated using at least a portion of the 3-D data:
i) to render a particular object or objects within the packed bag; and
ii) to discard obstructing structures to clearly render the object of interest.

18. The method of claim 1, wherein automatically detected threats are clearly marked on the rendered views.

19. The method according to claim 1, wherein the rendered view comprises a surface rendering, the surface rendering utilizing a ratio of diffuse and specular reflections.

20. The method according to claim 1, wherein the rendered view comprises a volume rendering, the volume rendering utilizing one or more colors and opacity values.

21. The method according to claim 1, wherein the rendered views are shared across a network.

22. The method according to claim 1, wherein the scanner comprises at least one of a computed tomography (CT) scanner, a cine computed tomography scanner, a helical CT scanner, a four-dimensional (4D) cine computed tomography scanner, an electron beam scanner, an x-ray scanner, a dual-energy x-ray scanner, dual-energy CT scanner, and a diffraction imaging (DI) scanner.

23. A system to analyze a content of a packed bag, comprising:
a memory to store scan data acquired while scanning a piece of baggage for a scannable characteristic, the scan data being representative of a content of the piece of baggage;
a processor for generating a volumetric data set from the scan data, the volumetric data set including voxel values for the scannable characteristic throughout a volume of interest in the piece of baggage;
a local workstation for producing a rendered view of the content of the piece of baggage based on voxel values within a selected range from the volumetric data set;
one or more remote display terminals to simultaneously show the rendered view; and
a server (TeleInspection Server, TIS) that continuously monitors the status of the local workstation and all remote display terminals.

24. The system according to claim 23, wherein the voxel values comprise a corresponding Hounsfield unit value.

25. The system according to claim 23, wherein the scannable characteristic is an attenuation measurement and comprises at least one of a surface and an edge of at least the baggage and objects contained within the baggage.

26. The system according to claim 23, wherein the processor produces a three-dimensional (3D) image based on voxel values as a rendered view.

27. The system according to claim 23, wherein the processor performs at least one of a surface rendering, a volume rendering, a maximum intensity projection rendering, a minimum intensity projection rendering, a multi-planar reformatting, and a radiographic projection of at least a portion of the volumetric data set.

28. The system according to claim 23, wherein the processor performs a surface rendering of at least a portion of the volumetric data set, the volume rendering utilizing a ratio of diffuse and specular reflections.

29. The system according to claim 23, wherein the processor performs a volume rendering of at least a portion of the volumetric data set, the volume rendering utilizing at least one of a color and an opacity.

30. The system according to claim 23, wherein the processor performs an automatic threat detection analysis of at least a portion of the volumetric data set based on the scannable characteristic.

31. The system according to claim 23, wherein the processor segments at least a portion of the volumetric data set based on the voxel values to identify an object.

32. The system according to claim 23, wherein the display provides a visual marker outlining the object based on the processor segmenting at least a portion of the volumetric data set based on the voxel values to identify the object.

33. The system according to claim 23, wherein the processor classifies the voxel values into a plurality of categories and segments the voxel values in at least one category.

34. The system according to claim 23, wherein the processor classifies the voxel values into a plurality of categories, the categories being at least one of an innocuous material, an organic material, and a metallic material.

35. The system according to claim 23, wherein the display permits a user to select a range of thresholds of selectable range for voxel values, the rendered view being produced only from voxel values that fall within the range.

36. The system according to claim 23, wherein the display permits a user to simultaneously display a surface rendered view and a volume rendered view of the content of the piece of baggage.

37. The system according to claim 23, wherein the display permits a user to interactively adjust a selectable range of voxel values to be utilized to produce the rendered view.

38. The system according to claim 23, wherein the display permits a user to zoom the rendered view in on a region of interest and display an enlarged image of the region of interest.

39. The system according to claim 23, wherein the display permits a user to rotate the rendered view and display the content of the piece of baggage from a new viewpoint.

40. The system according to claim 23 wherein the processor and the local workstation communicates with a plurality of other processors and local workstations over a high-speed connection to display the rendered view.

41. The system according to claim 23 wherein the local workstation requests Expert-on-Demand (EoD) service through a server (TeleInspection Server) using a client program (TeleInspection Client).

42. The system according to claim 23 wherein the local workstation requests Expert-on-Demand (EoD) service through a server (TeleInspection Server) using a client program (TeleInspection Client) with a list of preferred experts.

43. The system according to claim 23 wherein the server grants the EoD request of the local workstation by establishing a secure communication link to the requested remote expert or the first available remote expert.

44. The system according to claim 23 wherein any remote terminal requests a connection to any local workstation through the server for monitoring of the inspection process.

45. The system according to claim 23 wherein the server logs all communication data including, voice, text, images, video and mouse movements for future access.
